(19) United States
(12) Patent Application Publication
(10) Pub. No.: US 2004/0210515 A1
(43) Pub. Date: Oct. 21, 2004

(54) Deposit system and method of taking deposits

(76) Inventor: Grant Hughes, Oakville (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 10/417,159

(22) Filed: Apr. 17, 2003

(51) Int. Cl. G06F 17/60

(52) U.S. Cl. 705/39

(57) ABSTRACT

The present invention provides a deposit system and a method for receiving a deposit from a user. In an aspect, a deposit system for receiving a deposit from a user is provided. The deposit system includes a deposit processor having a user interface to permit the user to communicate deposit information to the deposit processor before the user makes the deposit, the deposit information including an indication of type of the deposit as being one of a cash deposit and a non-cash deposit; at least one safe operatively attached to the deposit processor, each safe being configured to receive at least one of a cash deposit and a non-cash deposit and each safe having a first lockable access thereto, the at least one safe capable of receiving cash deposits and non-cash deposits; and a reader, operatively connected to the deposit processor, to read a label of the deposit to identify the deposit using the deposit information. Upon the deposit being identified, the deposit processor unlocks the first lockable access for one of the at least one safe to permit the user to deposit the deposit therein.

### FIELD OF THE INVENTION

This invention relates to the general field of deposit taking, and more particularly to a system for accepting deposits of negotiable instruments such as cash, cheques and the like.

### BACKGROUND OF THE INVENTION

One of the primary functions of the banking industry is to accept deposits from members of the public, whether individuals or business entities. Deposits accepted by banks are credited to customer accounts and banks attempt to invest those funds to generate a return. Bank customers can make deposits with banks either electronically or in physical form. Physical deposits may include paper or coin currency, or clearing items such as cheques, credit card foils, value tokens, and the like. In the realm of physical deposit taking, there are a variety of commonly available customer access points, including bank branches with teller assistance, automated bank machines (ABMS) or automated teller machines (ATMs), and night depositories. These currently available deposit taking methods suffer from limitations and drawbacks, both from the perspective of the bank and the perspective of the customer, as outlined below.

While the traditional bank branch continues to be an important customer access point, from the customer's perspective, a traditional bank branch suffers from drawbacks such as limited hours of operation and lengthy waits in line-ups for assistance by tellers or other customer service representatives. From the bank's perspective, bank branches are a very large investment with a high proportion of fixed costs versus variable costs. Even the so called “variable cost” of labour in the branch is actually semi-fixed, as banking staff have to be paid whether customers are present at the branch or not. Furthermore, as the volume of branch transactions increases, it is not always possible to add capacity easily (other than perhaps labour). Conversely, as such volume decreases, the level of idle capacity increases and is difficult to remove readily.

As for ABMs or ATMs, from the customer's perspective, the typical ABM suffers from the limitation that it was primarily designed for cash dispensing and not primarily for deposit taking. Many ABMs only permit envelope sized deposits of cheques or cash, and often do not accept deposits of coins, although specialized coin-counting and deposit machines do exist. As a result, the amount of internal space in an ABM dedicated to accepting deposits is very limited. There are also possible deposit identification problems associated with many known ABM designs. ABM deposit envelopes are usually tracked by a number physically printed by the ABM onto the envelope. This identification process may be prone to error however, such as when the ABM printer runs low on printer ink. This may result in missing or delayed deposit processing. These and other limitations place significant constraints on customers who want to use an ABM for more than the occasional deposit.

Another problem with ABMs generally is that the ABM typically houses not only the cash supply, but also the serviceable equipment. Because of the risk of exposing service personnel to cash, ABM servicing is normally done under dual custody with an armoured carrier. This is unnecessarily costly. Furthermore, the integrated design of most ABMs leaves them incapable of adapting readily to changes in capacity requirements. For instance, with many existing ABM designs, an under-utilized ABM can only be withdrawn from service and cannot be downsized, whereas an increased demand can only be delivered by an entire new machine and the over-utilized ABM cannot itself be upsized.

As for the night depository, this traditional customer access point for making commercial night deposits has existed for over a century. Typically, the facility itself generally comprises a deposit head or lockable drawer into which the customer deposits a closed bag containing the funds. A safe or vault located under the drawer receives the deposited bag. These facilities may be located at an existing bank branch or at an independent site. Such night deposit facilities may be accessible from within an interior room such as those housing ABM facilities, or from an exterior wall on the outside of a building. The deposit head or drawer is specially designed to prevent theft by anyone reaching in or fishing to hook a bag in the safe. Normally, the bank will issue master keys to the drawer of a night depository only to its commercial customers from whom it has agreed to accept such deposits.

The method of processing of the deposits to a night depository can vary depending on the bank's policy or the resources of the particular branch. In some cases, the safe is opened inside the branch, which collects the deposits and credits the customer accounts. In other cases, and particularly where the night deposit facilities are remotely located, the deposit bags are collected regularly by an armoured carrier company (“ACC”). The ACC will usually pick up the deposit bags from several locations and transport them to a central bank site where they are organized and distributed to the bank's central processing facility.

From the customer's perspective, the most significant drawback of the night depository is the lack of a receipt or other verification that the deposit was made, and the resultant possibility that the customer may not be credited with the deposit. Deposit bags can go missing for several reasons. In some cases, the customer may have never actually made the deposit in the first place. For example, an employee assigned to make the deposit may have neglected to do so and forgotten to inform the employer. Another reason is that the deposit bag may be temporarily misplaced by the ACC. The bag could have been left behind in the night deposit safe or the carrier's armoured vehicle, or been misplaced at the central routing station of the armoured car company. Yet another possibility is that the bank itself could misplace the bag, or may improperly process the deposit. For example, in some banks, customer account numbers are not unique, in that only the combination of a branch transit number and a customer account number is unique. Therefore, if the branch number is missing or incorrectly recorded, deposits can be credited accidentally to the wrong customer. Whatever the reason, a lengthy and costly process to track a lost deposit may have to be initiated between the bank, the ACC and the bank customer.

Still another problem associated with the typical night depository is that cheques and cash are often placed together by the customer into the same night deposit bag. Therefore, the bank is required to separate and sort the cash from the cheques, each of which are treated very differently. This is sometimes undesirable because when cheques are combined with cash deposits in the same deposit bag, they become subject to the same costly security, transport, and safekeeping procedures as cash. However, cheques are a more secure form of instrument since they are payable to a specific named party rather than to the bearer. Therefore, cheques do not require the same stringent security arrangements as cash, and their treatment as a cash equivalent may be costly and unnecessary.

More recently, a hybrid process which requires the use at two distinct banking machines has been introduced by some banks as a possible work-around to the limitations of both channels. Generally speaking, the process involves a customer declaring the deposit at an ABM and then separately dropping the deposit bag into a night depository. However, one part of the foregoing process is electronic (deposit declaration at the ABM), while the other part is manual (actual deposit at the night depository). Thus, matching of the deposit declaration at the ABM to the actual deposit in the night depository can be very cumbersome. This process could potentially create delays in any debit or credit adjustment arising on physical balancing (i.e. counting the value items) by the bank, and furthermore may create additional effort in reconciling customer records with bank records.

The above noted limitations associated with various customer access points for making bank deposits may result in continued high costs for banks and considerable inconvenience for their customers.

### SUMMARY OF THE INVENTION

What is desired is a deposit system and method of taking deposits which attempts to overcome or alleviates one or more of the problems associated with the existing customer access points for making deposits of cash and non-cash instruments.

More particularly, such a system and method should attempt to overcome or alleviate at least some of the limitations of ABMs, night depositories and their hybrids to provide a customer with a deposit solution comparable to that which exists in bank branches with teller assistance. For example, in order to overcome the drawbacks of night depositories, such a system and method should preferably track the amount and type of the deposit, as well as the location and movement of the deposits as they pass through the deposit process. In this way, responsibility for the deposit between the customer, bank, and armoured carrier company will be known at all times. In addition, knowing the amount, type and the location of the deposit will permit urgent processing of large deposits, if desired. Preferably, the system will permit both depositors and deposit takers to become aware shortly after the onset of any problem with the location or safekeeping of the funds or the integrity of the deposit. Ideally, such a system and method will alert the parties promptly so that remedial action can be taken. Preferably, such a system and method may also provide for separate deposit and safekeeping of different types of negotiable instruments, such as cash and non-cash deposits like cheques. As well, such a system can comprise system components and transportation arrangements having a degree of security appropriate to the type of deposit being handled. In addition it is preferable if the bulk of the serviceable equipment is accessible without directly exposing the service personal to the deposits, to minimise security concerns and expense.

Accordingly, in a first aspect, a deposit system for receiving a deposit from a user is provided. The deposit system includes a deposit processor having a user interface to permit the user to communicate deposit information to the deposit processor before the user makes the deposit, the deposit information including an indication of type of the deposit as being one of a cash deposit and a non-cash deposit; at least one safe operatively attached to the deposit processor, each safe being configured to receive at least one of a cash deposit and a non-cash deposit and each safe having a first lockable access thereto, the at least one safe capable of receiving cash deposits and non-cash deposits; and a reader, operatively connected to the deposit processor, to read a label of the deposit to identify the deposit using the deposit information. Upon the deposit being identified, the deposit processor unlocks the first lockable access for one of the at least one safe to permit the user to deposit the deposit therein.

Each first lockable access may include a lockable transfer slot and each safe may further include a second lockable access for removing deposits deposited therein.

At least one of the safes may include a drop sensor to sense passing of the deposit through the lockable transfer slot thereof.

The user interface may include a user identification means to identify the user.

The user identification means may include a card reader.

The deposit system may further include a remote processor and the deposit processor may communicate user identification information and the deposit information to the remote processor.

The deposit system may further include a remote terminal configured to permit the user to communicate the deposit information remotely to the deposit processor.

The deposit system may further include a controller cabinet having serviceable equipment located behind a lockable door, the controller cabinet housing the deposit processor and the reader, the lockable door being separate from each of the first lockable accesses.

The deposit system may further include at least one sensor associated with the serviceable equipment to sense a status of the serviceable equipment to facilitate servicing the serviceable equipment.

The deposit system may include at least two safes and one safe of the at least two safes may operate to receive cash deposits and another safe of the at least two safes may operate to receive non-cash deposits, each of the at least two safes may be operatively connected to the deposit processor.

The one safe which operates to receive cash deposits may be more securely built than the another safe which operates to receive non-cash deposits.

Each first lockable access of each safe may include a lockable transfer slot operatively connected to the deposit processor to receive the deposit therein and each safe may further include a second lockable access through which to access the safe for removing deposits deposited therein.

The deposit system may include at least two safes and one safe of the at least two safes may operate to receive deposits to be deposited in an account held by a first financial institution and another safe of the at least two safes may operate to receive deposits to be deposited in an account held by a second financial institution, each of the at least two safes may be operatively connected to the deposit processor.

The deposit system may include at least two safes and one safe of the at least two safes may operate to receive deposits to be processed by a first processing facility and another safe of the at least two safes may operate to receive deposits to be processed by a second processing facility, each of the at least two safes may be operatively connected to the deposit processor.

The reader may be one of a bar-code reader, a radio frequency reader, a magnetic strip reader and an optical character recognition reader.

The deposit system may further include a means to read the label of the deposit upon the deposit being removed from the safe into which the deposit was received.

The reader may be a first reader and the means to read the label upon the deposit being removed from the safe into which the deposit was received may include a second reader.

The deposit system may further include a means for producing a signal indicating identification by the second reader upon the deposit being removed from the safe into which the deposit was received.

The second reader may be one of a bar-code reader, a radio frequency reader, a magnetic strip reader and an optical character recognition reader.

The deposit system may further include at least one deposit container bearing the label of the deposit in which the user places the deposit.

The label may include a unique identifier.

The deposit information may include the unique identifier to identify the deposit container containing the deposit.

The deposit information may further include at least one of an identity of the user, an amount of the deposit and an identity of an account into which the deposit is directed to be deposited.

The label may include at least one of an optical bar-code, an electronic radio frequency tag, a magnetic encoding strip and alphanumeric text.

In a second aspect, a deposit system for receiving deposits is provided. The deposit system includes at least one secure deposit unit configured to receive at least one uniquely identified deposit container from a user, each deposit unit including user identification means for identifying the user and deposit container identification means for identifying each uniquely identified deposit container upon deposit by the user at one deposit unit of the at least one deposit unit, each uniquely identified deposit container being configured to contain a type of deposit being one of a cash deposit and a non-cash deposit, but not both.

In a third aspect, a method of receiving a deposit from a user is provided. The deposit is received at a deposit unit. The method includes the steps of: (i) identifying the user making the deposit, the deposit contained in an uniquely identified deposit container being configured to contain a type of deposit being one of a cash deposit and a non-cash deposit, but not both; and (ii) identifying the uniquely identified deposit container upon deposit at the deposit unit.

In a fourth aspect, a deposit system for receiving a deposit from a user is provided. The deposit system includes a deposit processor having a user interface to permit the user to communicate deposit information to the deposit processor before the user makes the deposit; at least one safe operatively attached to the deposit processor, each safe being configured to receive the deposit and having a first lockable access thereto; a first reader, operatively connected to the deposit processor, to read a label of the deposit so as to identify the deposit, wherein upon the deposit being identified, the deposit processor unlocks the first lockable access corresponding to one safe of the at least one safe to permit the user to deposit the deposit therein; and a second reader, operatively connected to the deposit processor, to read the label of the deposit upon the deposit being removed from the one safe.

### BRIEF DESCRIPTION OF THE DRAWINGS

Reference will now be made, by way of example only and not by way of limitation, to preferred embodiments of the invention as illustrated in the attached figures.

FIG. 1 is a schematic block diagram showing a deposit system and method in accordance with an embodiment of the present invention;

FIG. 2A is a perspective view of an exemplary deposit unit used in the deposit system of FIG. 1;

FIG. 2B is a view of the deposit unit of FIG. 2A, showing a deposit head in an open position ready to receive a deposit bag;

FIG. 2C is a view of the deposit unit of FIGS. 2A and 2B, showing a deposit bag being removed from a safe for armoured carrier transport to a central repository;

FIG. 3A is a first part of a process diagram showing a cheque and cash deposit process at the deposit unit of FIGS. 2A-2C;

FIG. 3B is continuation of the process diagram of FIG. 3A; and

FIG. 3C is a further continuation of the process diagrams of FIGS. 3A and 3B.

### DETAILED DESCRIPTION OF THE PREFERRED EMBODIMENTS

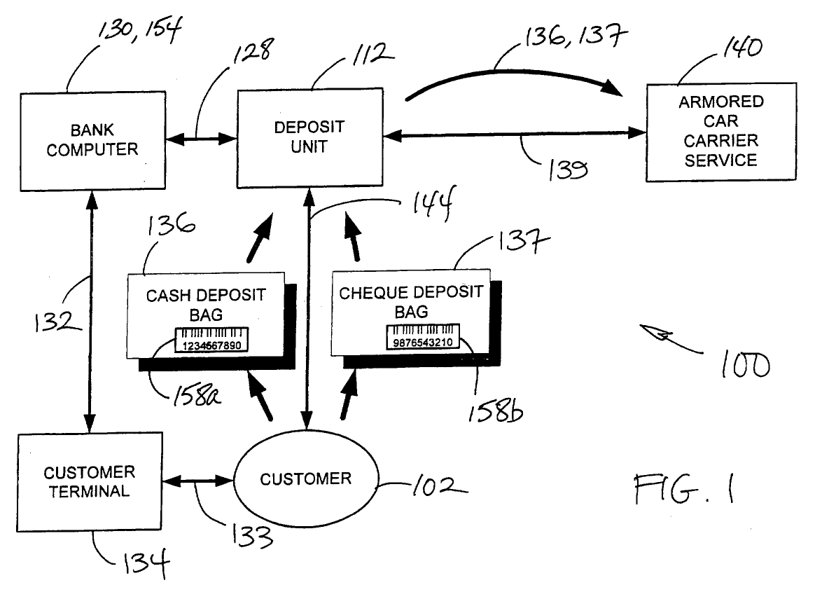

A schematic block diagram of a deposit system 100 in accordance with an embodiment of the invention is shown in FIG. 1. A user or customer 102 is represented schematically and is shown physically and locally interacting with a deposit unit 112 through a user interface 144. In this example, the customer 102 is shown depositing either or both of a cash deposit bag 136 and a non-cash deposit bag 137 into the deposit unit 112. Each cash deposit bag 136 and each non-cash deposit bag 137 is uniquely identified, for example by using unique bar-code labels 158a, 158b. Most preferably the labels are applied to the deposit bags 136 and 137 before the deposit is made. It will be appreciated that various other forms of unique identification of the deposit containers may be used, such as radio frequency tagging and the like. In this specification the term label comprehends any form of mark, tag or identifier, which is affixed or otherwise associated with a deposit package to provide a way of identifying the deposit package. Also, while the term “deposit bag” or “deposit package” is used here for convenience, it will be appreciated that any suitable type of deposit container may be used. The non-cash and cash deposit process used by the customer 102 at the deposit unit 112 is detailed further below.

The user or customer 102 optionally remotely interfaces with a bank computer 130 via a user or customer terminal 134 through interface 133. The customer terminal 134 may comprise, for example, a telephone or a computer. It will be appreciated that various other telecommunications technologies may be used for customer terminal 134. As shown, the customer terminal 134 may communicate with the bank computer 130 through a suitable communications link 132. In turn, the bank computer 130 communicates with the deposit unit 112 through a suitable communications link 128. The bank computer 130 and customer terminal 134 are generally remotely located relative to the deposit unit 112. The interaction between the customer 102, the customer terminal 134, the bank computer 130 and the deposit unit 112 is detailed further below.

Still referring to FIG. 1, an armoured carrier company or ACC 140 may also interact with the deposit unit 112 through interface 139. The ACC 140 periodically collects cash deposit bags 136 and non-cash deposit bags 137, deposited into the deposit unit 112 by one or more customers 102, for transport to a central processing facility (not shown). The interaction between the ACC 140 and the deposit unit 112 at interface 139 is detailed further below.

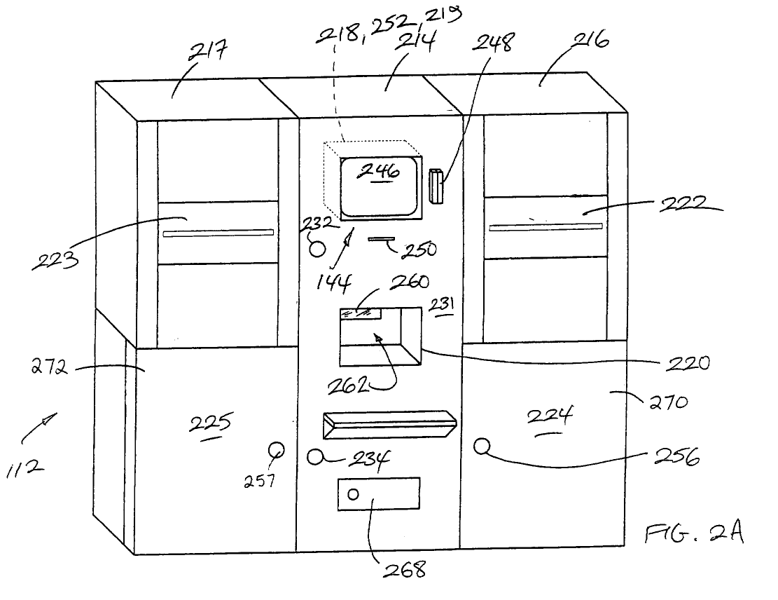

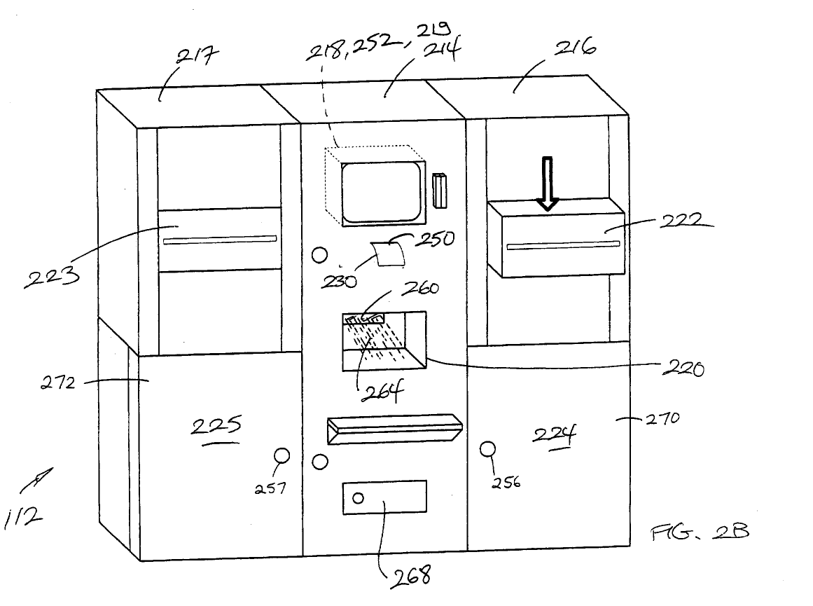

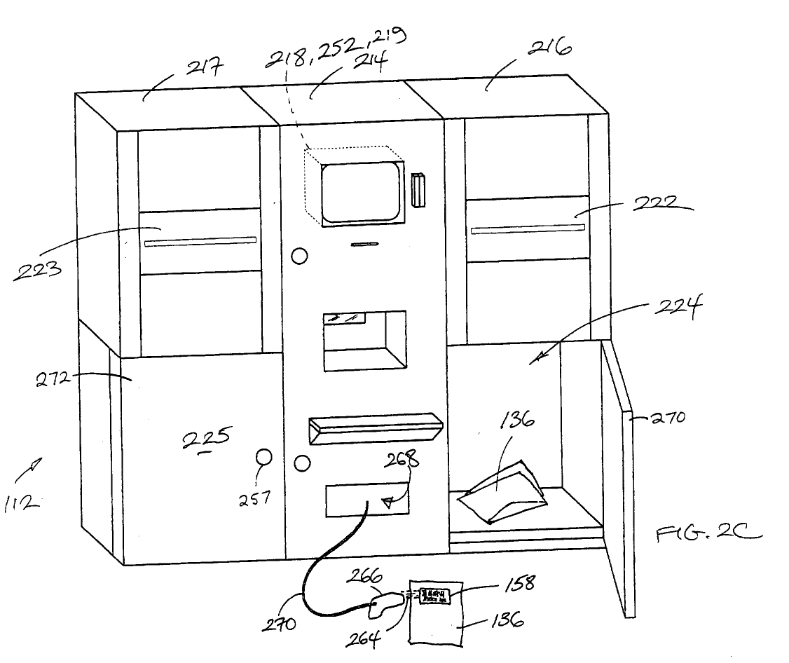

Now referring to FIG. 2A, and still referring to FIG. 1, details of an exemplary deposit unit 112 are shown. In this embodiment, the deposit unit 112 includes a control cabinet or controller 214 and two secure storage modules 216 and 217. The controller 214 houses a processor 218 and an identifier 220. The identifier 220 identifies the deposit package, for example by reading the label. In FIG. 2A the control cabinet or controller 214 is shown flanked on either side by the first storage module 216 and the second storage module 217. The storage modules 216, 217 each respectively generally include a deposit head, drawer, or lockable transfer slot 222, 223, and a safe or lockable access 224, 225. In particular, first storage module 216 contains a first lockable transfer slot 222 and first safe 224, and second storage module 217 contains a first lockable transfer slot 223 and second safe 225. Additionally, first safe 224 has a second lockable access 270. Security personnel of the ACC 140 or the like open second lockable access 270 to access deposits inserted by customers 102 into safe 224. Similarly, second safe 225 has a second lockable access 274 through which security personnel of the ACC 140 or the like access deposits inserted by customers 102 into safe 225.

While two storage modules 216, 217 are shown by way of example, it will be appreciated that, in alternative embodiments, either a single storage module, or more than two modules may be used. This modular architecture permits a single controller 214 to control any number of storage modules 216, 217 operatively connected thereto. More specifically, each storage module 216, 217 comprises a separate housing which includes an independently accessible safe 224, 225. As will be appreciated, the number of storage modules 216, 217 used may be determined based on capacity requirements and the need to separate the type of deposit. Furthermore, as discussed in further detail below, this modular architecture enhances security when the controller 214 is serviced or deposits are withdrawn from a safe 224, 225 in one of the storage modules 216, 217.

(processors) Still referring to FIG. 2A, processor 218 includes an element that permits the customer 102 to communicate deposit information prior to making the deposit. Most commonly and discussed in further detail below, the processor 218 comprises a board-level personal computer or similar logical device 219, together with related applications software. Logical device 219 is preferably located inside the control cabinet 214. (Due to its positioning inside the control cabinet 214, the logical device 219 is shown in dotted outline). As will be explained below, the processor 218 may be configured to provide various management and control tasks required to be performed by the controller 214. The processor 218 may also be used to process control signals and data between the deposit unit 112 and the bank computer 130.

In the embodiment shown in FIG. 2A, processor 218 is operatively connected to a user interface 144 that comprises a computer display screen 246, a card reader 248, a printer outlet 250, an uninterruptible power supply (not shown), and identifier 220. In order to provide a flexible, readily configurable, intuitive user interface, the computer display screen 246 is preferably a touchscreen. Otherwise, a dedicated computer input device such as a keyboard would be included as part of the user interface 144. It will be understood that the user interface 144 may be provided with any number of different user identification methods or technologies including, for example, electronic identification tokens, or biometrics readers in place of the card reader 248.

According to a preferred embodiment, the processor 218 can be viewed as comprising two parts: (i) a local processor 252, such as the logical device 219 that is located in or about the deposit unit 112 as previously explained, and (ii) a remote processor 154 (FIG. 1), such as bank computer 130 that is located remote from the deposit unit 112. The remote processor 154 may be a computer operated at a central location by the bank which owns or operates the deposit unit 112.

System management software operating on the remote processor 154 may enable the remote processor 154 to manage a multiple number of deposit units 112. The remote processor 154 may therefore be considered to manage a multiple user interface, the interface including each particular computer screen display 246 seen by a customer 102 at each deposit unit 112 as shown for the deposit unit 112 seen in FIG. 1.

(safes) The storage modules 216 and 217 function to safeguard the deposits 136, 137 until collection. Accordingly, the modules 216, 217 must be secure and highly resistant to tampering and infiltration. As a result and consistent with common practice, the drawers 222 and 223 are constructed to prevent anyone from reaching in with an arm, stick, or fishing line to retrieve a deposit bag 136, 137 deposited by a previous customer 102. Similarly, the safes 224 and 225 are preferably constructed robustly with relatively thick walls and strong hinges and with an effective locking mechanism. The safes 224, 225 are lockable and are preferably locked by a combination lock 256, 257, respectively, but it will be appreciated that the invention comprehends other means of locking the safes 224, 225 to prevent access except by authorized persons. In the exemplary deposit unit 112 shown in FIG. 2A, the first safe 224 is configured to receive one type of deposit, namely cash deposits, and the second safe 225 is configured to receive another type of deposit, namely non-cash deposits. Although the only types of deposits described are cash and non-cash deposits, it will be appreciated that deposits may be further or differently subdivided depending on their contents and separate safes 224, 225 may be provided for each different type of deposit contemplated. For example, in another embodiment, deposits could be separated depending on the financial institution that holds the account. A first safe could be provided for deposits directed to accounts at a first financial institution and a second safe could be provided for deposits directed to accounts at a second financial institution. In yet another embodiment, deposits could be separated depending on the processing facility that processes the deposit. A first safe could be provided for deposits to be processed by a first processing facility and a second safe could be provided for deposits to be processed by a second processing facility. Deposits for accounts held by different financial institutions may be commingled, rather than separated, if the deposits are directed to the same processing facility. As with all separations between types of deposits contemplated, separation of deposits may occur in a single safe, for example, by directing deposits into separate bags' in the same safe.

In a banking environment, non-cash deposits most commonly comprise cheques drawn on a reserve owned or managed by a bank or other financial institution. However, the invention comprehends other types of non-cash deposits such as, for example, bonds, securities, depository receipts, and bank certificates of deposit. Cash storage is typically subject to more stringent or secure requirements since, once acquired, cash can be spent freely without restriction. By contrast, the use of non-cash deposits such as cheques by unauthorized users is often restricted or prevented. Accordingly, it will be appreciated that while both safes 224 and 225 are preferably strong and secure, second safe 225 can be constructed to a less stringent and less costly standard than first safe 224 since its use is directed to holding non-cash deposits only.

The separation of deposits by type (i.e. cash and non-cash) as described above may be performed when two or more storage modules 216, 217 are being used with the deposit unit 112. However, where only a single storage module is being used which will receive both non-cash deposits and cash deposits, such a storage module should meet the standard for cash deposits. In this case, the cash deposit bag 136 and the non-cash deposit bag 137 are preferably differentiated. According to one aspect of the present invention, the non-cash deposit bags 137 are made from transparent plastic to show their contents, whereas the cash deposit bags 136 are made from opaque material. Various other methods of differentiation, including the use of different colours or materials for the deposit bags 136, 137, are also comprehended by the present invention. In this manner, the non-cash and cash deposits stored in a single storage module can be readily distinguished and processed by the ACC 140.

Still referring to FIG. 2A, the drawers or transfer slots 222, 223, which are referred to herein as first lockable accesses, are also lockable. Unlike a conventional deposit system which relies on a master key issued to a customer 102, the drawers 222, 223 are preferably locked electronically under the control of the processor 218. The processor 218 unlocks the appropriate drawer 222, 223, depending on the type of deposit as identified by the customer 102. (While local processor 252 may be provided with local control of the drawers 222, 223, it will be appreciated that the remote processor 154, at bank computer 130, will issue the open and lock instructions to the local processor 252 during the typical depositing process described in greater detail below.) This arrangement can be implemented through activation of a solenoid which moves to selectively permit or prevent opening of the drawers 222, 223, although it will be appreciated that other methods may also be used. For security purposes, the deposit unit 112 is preferably configured so that if power to the unit 112 is lost, the drawers 222 and 223 will default into a locked position. In any event, additional barriers may be used inside the storage modules 216, 217 (not shown) to secure the top of each safe 224 and 225 so that failure of the drawers 222, 223 will not leave the safe 224, 225 vulnerable.

It will be appreciated that the configuration shown in FIG. 2A, in which the controller cabinet 214 is positioned between the two storage modules 216 and 217, can also be varied as long as the processor 218 retains electronic control of the lockable transfer slots 222 and 223. For example, the controller 214 could be positioned at an end of the deposit unit 112, with the two modules 216 and 217 side-by-side, or even placed physically separate and apart from the two modules 216, 217.

The controller cabinet 214 includes a separate door 231 with individual locks 232, 234 to permit service access behind the door 231. The controller cabinet 214 contains the bulk of the serviceable equipment such as the user interface 144, including the computer display screen 246, the card reader 248, the printer outlet 250, the power supply (not shown), and the identifier 220. Thus the present invention comprehends providing separate access to the serviceable equipment of the user interface from the access to the deposit taking safes 224, 225 as explained in more detail below. In this manner security personnel need not be involved when routine servicing of the serviceable equipment located in the cabinet 214 occurs.

In addition, the present invention comprehends including appropriate sensors of the serviceable equipment to permit the deposit system to remotely monitor the status of the serviceable elements to both detect any problems that might arise as well as to arrange for appropriate periodic maintenance (such as identifying when the printer ink is low, for example). The use of such sensors permits efficient service scheduling, for example after a predetermined number of deposits, rather than merely on a periodic time based schedule. As well, such sensors allow the immediate dispatch of service personnel upon a malfunction being detected.

Other elements of the system will still require security personnel for service and maintenance. For example, servicing of the solenoid locks, the drop bag sensors and the lock sensors, all of which are located within the safes 224, 225, will require security personnel.

In each storage module 216, 217 the drawers 222, 223 are positioned so that upon insertion of a deposit bag 136, 137 the bag will move into the corresponding safe 224, 225. This is most conveniently accomplished by positioning the drawer 222, 223 above the safe 224, 225, so that the bag 136, 137 will fall under the influence of gravity into the safe 224, 225. However, it will be appreciated that other configurations may also be implemented to achieve the same effect. Since the drawers 222 and 223 are lockable under the local control of the processor 218 (and remotely controlled by the remote processor 154), it will be appreciated that the safes 224 and 225 are in effect operatively attached to the processor 218, whether or not same are physically proximate thereto.

(identifiers) The identifier 220 is an element that identifies the deposit package so that it can be uniquely recognized by the deposit unit 112. The identifier 220 is operatively connected to the processor 218, and therefore is able to communicate the unique deposit identification information to the processor 218. Most preferably the unique identifier is in the form of a label applied to the deposit package. If the label is affixed to the deposit package before the customer 102 places a deposit in the deposit bag, the customer 102 can then to communicate an intention to make a deposit, for example, location remote from the deposit unit 112. Alternately the present invention comprehends the application of the unique identifier or label upon attendance at the user interface 144 of the deposit unit 112. In either case the present invention comprehends that the deposit system recognise the deposit package by means of the identifier 220. The present invention then confirms that the identified or recognised package has been deposited into the safe 224, 225, for example, by means of a drop sensor or the like.

In the system 100 of the present invention, a deposit package preferably comprises a night deposit bag, such as cash deposit bag 136 or non-cash deposit bag 137, containing respectively cash or non-cash funds desired to be deposited by the customer 102 in the customer's account at the bank. Various tamper-evident security features may be built into the deposit bags 136, 137 such that when the deposit bags 136, 137 are filled with the funds and sealed by the customer 102, attempts to tamper with or re-open the deposit bags 136, 137 at any point before they reach the deposit processing centre will be readily apparent. Preferably, in addition to being readily distinguishable as between cash and non-cash deposits, the deposit bags 136, 137 include the unique identification element such as the bar-codes 158a, 158b shown on their outside surface (FIG. 1). Bar-code symbols 158a and 158b provide low cost and practicality in enabling computerized tracking of large numbers of discrete items. However, it will be appreciated that other types of identification elements are also comprehended such as, for example, a code, number or alphanumeric text either printed on a surface of the deposit bags 136, 137 or embedded in an electronic chip attached thereto. The code or number may be readable by a bar-code or an optical character recognition reader.

It will be appreciated that the present invention also comprehends other forms of deposit bags 136, 137. In the context of the present system 100 (FIG. 1) deposit bag 136, 137 means any form of closed package or container which is capable of containing goods placed therein by a customer 102 and carrying a unique label or identifier, such as the bar-code 158a and 158b, recognizable by the deposit unit 112.

Accordingly, in the present example, the identifier 220 is preferably a bar-code reader. In particular, there is a first bar-code reader 260 housed inside the control cabinet 214. The first bar-code reader 260 is fixed in position adjacent to a cavity 262 located in the control cabinet 214. Prior to being deposited, the labels on the deposit bags 136, 137 are scanned to identify the deposits. To do this, the deposit bags 136 and 137 are placed in the cavity 262. The first bar-code reader 260 emits radiation 264 (FIG. 2B), which upon reflection from the bar-code label 158a and 158b can be read or interpreted by the electronics of the bar-code reader 260 in a known manner. The bar-code information will generally comprise a number or letter-number code combination. The information in the code preferably includes one or more of a customer identification number, a deposit bag identification number and a content identification code for cash or non-cash. Other information may also be included in the label, depending upon the available space. The deposit unit 112 of the present invention also preferably includes a second bar-code reader 266 (FIG. 2C). As shown in FIG. 2C, this second bar-code reader 266 is preferably a manual or hand-held device housed inside an enclosure 268 located at or near the bottom of the control cabinet 214 (and near the safes 224, 225). The second bar-code reader 266 may maintain an electrical and physical connection to the cabinet 214 through an electrical cord 270, although a battery powered, wireless, hand-held unit may also be used. The second bar-code reader 266 is provided as a convenience to facilitate scanning of the deposit bags 136, 137 by security personnel of the ACC 140 as the bags 136, 137 are removed from the safes 224, 225. In FIG. 2C, the second bar-code reader 266 is shown emitting radiation 264 at the bar-code 158a of a deposit bag 136. Like the first bar-code reader 260, the second bar-code reader 266 is operatively connected to the processor 218, and therefore transmits the unique identification of the particular bar-code 158a to the processor 218. In this way, each deposit bag 136, 137 is scanned into the processor 218 by first bar-code reader 260 before being placed in the appropriate safe 224, 225, and is scanned out by second bar-code reader 266 when removed from the safe 224, 225. As can now be appreciated, although first and second bar-code readers are described, the same bar-code reader or the identifier could be used to recognise and record both the deposit and the removal of the deposit containers. What is comprehended is that the system of the present invention permits the scanning in of a uniquely identified deposit bag 136, 137 and then preferably the scanning out of the same deposit bag 136, 137 from the safe 224, 225. It will be appreciated that deposit unit 112 may use other means of tracking deposit of uniquely identified deposit bags 136, 137 into safes 224, 225 and removal thereof other than the method of scanning bar-codes 158a, 158b described above.

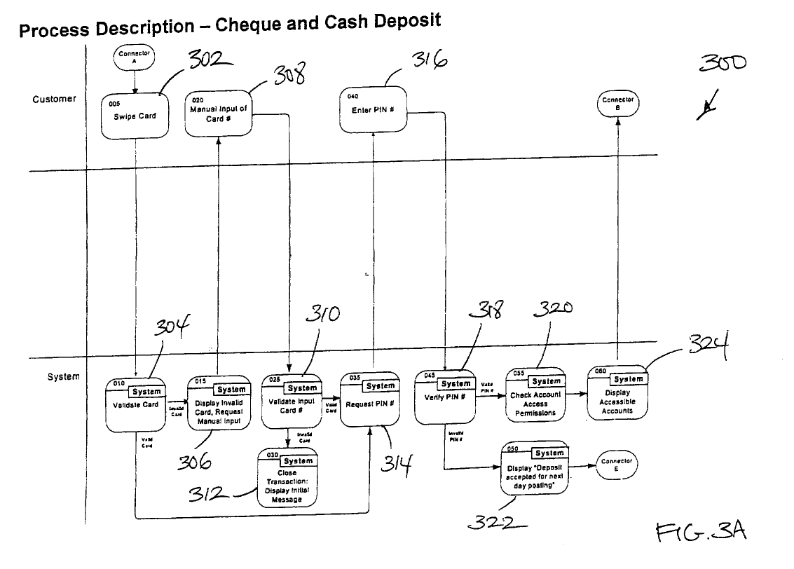

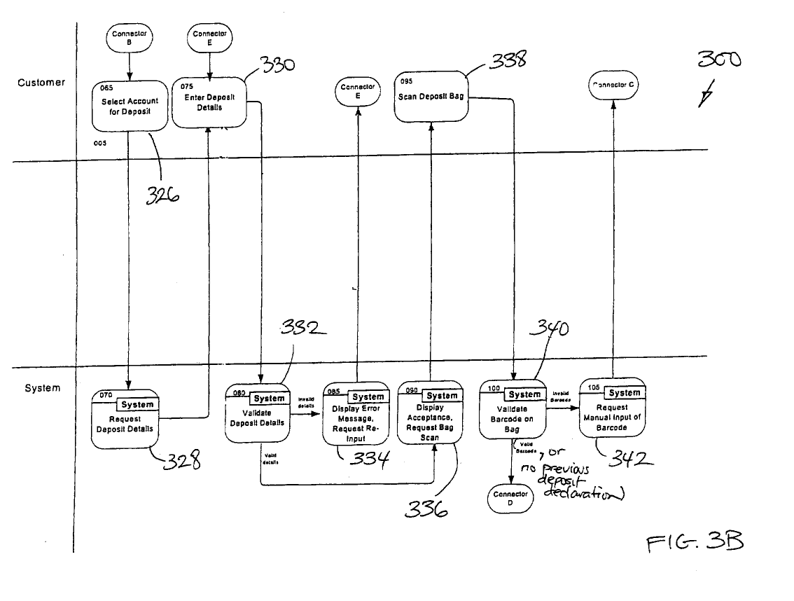

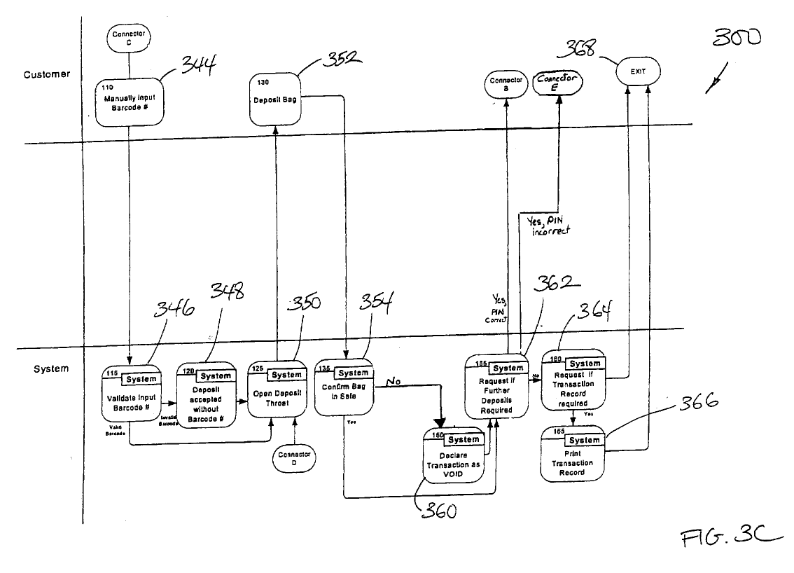

(operation—customer deposit) The operation of an embodiment of the present invention can now be described with reference to FIG. 1, and to FIGS. 3A-3C. As shown in FIG. 1 system 100 provides a method of accepting deposits from a customer 102 which comprises, as a first step, providing a deposit device such as the deposit facility or unit 112 described above. The invention comprehends placing the unit 112 at any location convenient for the customer 102, including locations commonly used for ABMs or night depositories. Thus the deposit unit 112 may be attached to an existing bank branch, another building, or at a stand-alone site. As discussed, the local processor 252 in the deposit unit 112 is capable of communicating with a remote processor 154 at the bank computer 130, which in turn can communicate with the remotely located customer 102. Similarly, the customer 102 may access the remote processor 154 (bank computer 130) remotely through the customer terminal 134, which can be, for example, a telephone or computer having Internet access. The communication lines 128 and 132 are accordingly any type of telecommunication connection such as wired cables or a wireless system that provides voice or data access.

Operation commences with the decision by the customer 102 to make a deposit into its account at the bank, of cash, cheques or other non-cash instruments, or both. The present invention comprehends, in one embodiment, that the customer 102 establishes a connection with the remote processor 154 through the terminal 134, and uses the connection to communicate information about a proposed deposit as set out below. Most likely the customer 102 will be located at or in close proximity to their business or residential premises, and remote from both the remote processor 154 as well as the deposit unit 112. Upon establishing communication with the remote processor 154, the customer 102 supplies uniquely identifying deposit information such as a customer number or other identification. Such information may be embodied in a card or other transportable device which can be read by the customer terminal 134, for instance by means of a magnetic strip card reader or the like. Alternatively, the same information may be manually entered by the customer 102 at the customer terminal 134, for instance by means of a keyboard or the like. Recognition of the uniquely identified deposit information permits the customer 102 to access a specific account on the bank computer 130. The customer 102 may then be prompted for various deposit details, including the amount of funds 138 being deposited, the type of funds, whether cash or non-cash, and the bar-code or other unique identifier of the bag 136, 137 in which the funds be deposited. It will be appreciated that these deposit details may be determined or provided in other ways. For example, the bar-code identifier may identify the deposit as being cash or non-cash. Optionally, the customer 102 may also identify when he or she expects to make the deposit by identifying the expected time or time-range of deposit.

In this way, the system 100 is apprised of the pending deposit in advance of the actual deposit. When the customer 102 arrives in person at a deposit unit 112 connected to system 100, he or she interacts with the user interface 144 located on the control cabinet 214.

While pre-declaring a deposit at a customer terminal 134 has been described above and is comprehended by the present invention, it will be appreciated that a customer 102 may also simply declare the deposit on site, upon arriving at the deposit unit 112 without making a pre-declaration. In a further alternative, the customer 102 may do both.

Now referring to FIG. 3A, a non-cash and cash deposit process for a customer 102 being present at the deposit unit 112 is shown and referenced generally by reference 300. In order to initiate a deposit session with the deposit unit 112, the customer 102 provides customer identification for validation purposes, for instance by the swiping of a magnetically encoded bank-issued identification card through the card reader 248 at block 302. As noted earlier, however, various other forms or mechanisms of customer identification may be used which are also comprehended by the present invention.

In this embodiment, the local processor 252 reads the card information and, at block 304, sends the information to the remote processor 154 to validate the card. If the card is validated by the remote processor 154, the local processor 252 is notified and process 300 proceeds to block 314. If the customer's card is not validated, at block 306 the computer display 246 displays a message that the card was not validated. Whereas the transaction would normally be terminated at this point at a regular ABM, the deposit unit 112 is designed to provide the customer 102 with the ability to manually enter the card number at block 308. At block 310, the card number manually entered at block 308 is validated, as at block 304 described above. If the customer 102 does not know the card number, the transaction is terminated at block 312. If the manually entered card number is valid, process 300 proceeds to block 314.

At block 314, process 300 requests that the customer 102 enter his personal identification number or PIN. The customer 102 enters his or her PIN at block 316. The PIN entered is verified at block 318, and if the PIN is valid, process 300 proceeds to block 320 to check the account access permissions stored in the bank computer 130 (via remote processor 154). If the PIN is invalid, process 300 proceeds to block 322 and the display 246 indicates that the deposit is accepted for next day posting. This way, a customer 102 with a valid card number can make a deposit even if the customer 102 has forgotten the PIN. At block 324, the accessible accounts are displayed on computer display 246. If the PIN is not correct, process 300 does not terminate the session. Rather, process 300 displays on computer display 240 a message that the deposit will be accepted for subsequent processing.

Following connector B from FIG. 3A to FIG. 3B, at block 326, the customer 102 selects the correct account for deposit, provided the previously entered PIN is correct. The bank computer 130 then requests the deposit details at block 328, and the details are entered by the customer 102 at block 330. For example, the deposit details may include the type of deposit (whether cash or non-cash) and the amount of the deposit.

Following connector E from FIG. 3A to FIG. 3B, if the PIN entered by the customer 102 at block 316 was not verified at block 318, the customer 102 would not have access to the accounts at blocks 324 and 326. Rather, the customer 102 would come directly to block 330 to enter the deposit details.

At block 332, the deposit details entered at block 330 are validated. If the deposit details are invalid, process 300 proceeds to block 334 where an error message is displayed and the customer 102 is brought back to block 330. If the deposit details are valid, process 300 proceeds to block 336 where the deposit request is validated and the customer 102 is requested to scan the deposit bag 136 or 137.

In the illustrative embodiment, at block 338, process 300 waits for the customer 102 to position the deposit bag 136 or 137 inside the cavity 262 so that the radiation 264 impinges on the bar-code 158a or 158b, enabling it to be read by the first bar-code reader 260 as described earlier. Preferably, there will be an audible beep or a visual display on the display 246 to indicate that the bar-code 158a or 158b has been successfully read by the system.

At block 340, process 300 attempts to validate the bar-code 158a or 158b on the deposit bag 136 or 137 scanned by the customer 102. The validation process may include, for example, confirmation that the deposit identity is identical to that which may have been communicated to the bank computer 130 earlier by the customer 102 using customer terminal 134. If there was no previously declared deposit, no validation takes place.

At block 342, if the bar-code 158a or 158b is invalid or unreadable, the customer 102 may be requested to input the bar-code number manually. For this purpose, the bar-code 158a or 158b would have to have both the computer readable bars, and numeric or alpha-numeric characters that can be read by the customer 102.

Following connector C from FIG. 3B to FIG. 3C, the customer 102 manually inputs the bar-code 158a or 158b at block 344. The process 300 then attempts to validate the manually input bar-code at block 346. If the bar-code is still not valid, the deposit unit 112 will nevertheless accept the deposit at block 348.

Upon confirmation of the bar-code 158a or 158b, or even if the deposit is not confirmed, at block 350 the remote processor 154 at the bank computer 130 provides an instruction to the local processor 252 to unlock the first drawer 222 or second drawer 223, as appropriate, depending on whether the deposit is cash or non-cash, respectively. (As noted earlier, if only one storage module 216, 217 is being used in an embodiment, that storage module may be used to accept both cash and non-cash deposits.)

Prompting on the computer display screen 246 will inform the customer 102 that the appropriate drawer 222, 223 is now accessible. At this point, the display screen 246 preferably includes a graphical illustration (e.g. a graphical representation of the deposit unit 112 with the location of the drawer 222, 223 highlighted) to assist the customer 102 in identifying the correct drawer. At block 352, the customer 102 then proceeds to open the drawer 222 or 223, drop the deposit bag 136 or 137, and close the drawer 222 or 223. The deposit bag 136, 137 will fall into the first safe 224 or second safe 225, as appropriate.

As the deposit bag 136 or 137 is deposited into the deposit unit 112, the internal drop sensor (not shown) senses whether a deposit bag 136 or 137 has been actually deposited. If, at block 354, the deposit unit 112 confirms that the bag is in the safe 224 or 225, then process 300 proceeds to block 362. If the deposit is not confirmed at block. 354, process 300 proceeds to block 360 and the transaction is declared void.

Under command from the remote processor 154, the local processor 252 will then shut the drawer 222 or 223 completely so that it will be effectively re-locked. As a precautionary measure, failure to fully shut the drawer 222, 223 will preferably trigger the local processor 252 to cease taking further deposits and to contact the remote processor 154 to send security or maintenance personnel to investigate the situation.

At block 362, process 300 will inquire whether any further deposits are required. If yes and the customer 102 had previously entered the correct PIN, process 300 follows connector B back to block 326 to again select an account for deposit (FIG. 3B). If yes and the customer 102 had not previously entered the correct PIN, process 300 follows connector E back to block 330 to enter deposit details (FIG. 3B). If the customer does not require further deposits, process 300 proceeds to block 364 and requests if a transaction verification record is required. Upon request by the customer 102, at block 366, a deposit verification record 230 will be printed. The verification record 230 is removed by the customer 102 from the printer outlet 250 as shown in FIG. 2B. If the customer 102 forgets to remove the verification record 230 from the printer outlet 250, most preferably after a preset amount of time, the verification record 230 may be taken back into the machine. This will reduce the risk that the customer's account information will be disclosed to others. Alternatively, no retraction of a printed verification record 230 may be provided, in which case account information on the printed verification record 230 may be masked to avoid unintentional disclosure to others. From block 364 or 366, process 300 proceeds to block 368 and ends.

(operation—storage in safe) Referring back to process 300 (FIGS. 3A-3C) and FIG. 1, it will be appreciated that the method of accepting deposits from a user of the present invention enables the financial institution or bank to have a record, at any given point in time, of how many deposits have been made to each of its deposit facilities 112, and the amount of each deposit (subject to physical confirmation). This knowledge enables the bank to implement certain cost effective adjustments to its procedures, particularly with respect to scheduling ACC 140 pick-ups. For example, a scheduled pick-up can be cancelled ahead of time if it is known that there are no deposits, or even if the deposits are few and the sums involved small. Since customers 102 can be credited for the amount of the deposit in any event (again, subject to physical confirmation), they will not be inconvenienced by the delay in pick-up. Similarly, an unusually high number of deposits or large amount of cash could be managed more efficiently by scheduling an additional or earlier pick-up.

Another beneficial service made possible by the system 100 is that, upon receiving the initial information about the pending deposit, the processor 218 can monitor the deposit unit 112 for a predetermined time or until after the customer's expected time of deposit. If the deposit has not been made or the customer 102 has not communicated with the user interface 244 on the control cabinet 214 by the conclusion of that predetermined time, for whatever reason, an alert can be transmitted to the customer 102 and the appropriate bank authority. The alert can be in the form of an e-mail, telephone call, fax, or other communication.

(operation—carrier pick-up) The method of accepting deposits from a user of the present invention preferably further includes steps that facilitate pick-up or collection of the bags 136, 137. The security service or ACC 140 that arrives to collect the deposit bags 136, 137 will preferably identify itself, for instance by swiping an identification card with relevant magnetically encoded information through the card reader 248 and entering a PIN at the computer screen 246. However, as with customer identification, various other forms and mechanisms for identification may be used by ACC 140 personnel. Similarly, a validation process will preferably ensue as previously mentioned to confirm the identifying information provided by the ACC 140. As shown in FIG. 2C, the ACC 140 will then unlock a second lockable access 270, 272 which is secured by combination lock 256, 257 to open the safe 224, 225, exposing the deposit bags 136, 137 inside.

The processor 218 will preferably display a manifest on the computer screen that lists all of the bags 136, 137 in the safe 224, 225 whose contents are being removed. The ACC 140 will also open the enclosure 268 to access the second bar-code reader 266.

The ACC 140 will then proceed to remove the bags 136, 137, one at a time. The bar-code 158a or 158b of each bag 136, 137 will be scanned by the bar-code reader 266, and the processor 218 will preferably emit an audible signal or provide some other cue to confirm that the bag's code has been received. In a preferred embodiment, the signal may comprise an incremental numeric count which indicates the number of bags 136, 137 that have been scanned by the bar-code reader 266. The processor 218 will confirm that the bag 136, 137 being removed matches one of the bags listed on the manifest. If it is, the manifest display will be updated to indicate that the particular bag 136, 137 has been removed.

The above steps are repeated for each bag 136, 137 until all the deposit bags 136, 137 are removed from the safe 224, 225. Typically the ACC 140 will place the deposit bags 136, 137 removed from the safe 224, 225 into one or more larger storage bags that are each also identifiable, sealable, and tamper-evident in order to assist in maintaining the security of same during transport to a processing facility. The ACC 140 will preferably then inform the deposit unit 112 of the removal of the bags 136, 137, and the deposit unit 112 will confirm that all of the deposits bags 136, 137 identified in the manifest have been accounted for as having been withdrawn by the ACC 140. The manifest can be printed out from printer outlet 250 and taken by the ACC 140. Therefore the manifest listing all of the deposit bags 136, 137 removed can be both recorded in the system 100 and printed out as a reference for the ACC 140. The ACC 140 can then close the second lockable access 270, 272 of the safe 224, 225 and transport the sack(s) of deposit bags 136, 137 as aforesaid to a processing facility.

In an alternative embodiment, if an identification technology other than a bar-code 158a or 158b is used, such as an electronic chip identifier, it is possible that more than one deposit bag 136, 137 may be processed at a time. For example, if provided with a suitable sensor at the opening of the safe 224, 225, the removal of such a tagged deposit bag 136, 137 from the safe 224, 225 may instantaneously trigger a removal record.

It will be appreciated that if there is any discrepancy between the bags 136, 137 recorded by the system 100 as being inside the safe 224, 225, and the bags 136, 137 actually removed by the ACC 140, the discovery can be immediately communicated to all of the parties. The local processor 252 can inform both the ACC 140 at the deposit unit 112 and the appropriate official of the bank through the remote processor 154. In this way, the parties would be in a reasonable position to locate the source of the error and take appropriate remedial action. In the event that the pick-up proceeds smoothly, all of the parties will benefit from the knowledge that responsibility for the bags 136, 137 at this point rests with the ACC 140.

It can accordingly be appreciated that the deposit system 100 and associated method as aforesaid of the present invention provide an alternative to traditional customer access points for making deposits described earlier. Compared to the traditional bank branch with teller assistance, the system 100 and associated method can provide a deposit facility available to the customer 24 hours a day, 7 days a week. The system 100 and associated method can also accept a volume of deposits, and types of deposits, that cannot generally be accepted at traditional ABMs. Additionally, the present invention comprehends a modular design in which any number of safes 224, 225 can be joined to a single controller cabinet 214. Thus, the present invention comprehends and permits the addition or removal of deposit capacity to accommodate changes in the volume of customer transactions over time. More capacity can be added by adding additional safes 224, 225, operatively connected to an existing adjacent controller cabinet 214, without the need to supply and position any extra controller cabinets 214, which is both efficient and less expensive than the prior art designs.

Furthermore, in comparison to traditional night depositories, the deposit system 100 provides an automated deposit verification and tracking system. Specifically, the deposit system 100 and associated method enables the parties to track the location of the deposit funds, even prior to their deposit in the deposit facility. In this way, responsibility for the deposit can be ascertained at any time. If the funds happen to go missing, only the party known to be responsible as indicated by the records on the system 100 will need to re-trace its steps and pursue recovery procedures. The system 100 and associated method can also immediately identify lost or misplaced bags 136, 137 by permitting the bags to be traced into and out of the deposit unit 112. If the customer 102 notifies the bank in advance of the deposit, the system 100 will be alerted of a failure to deposit immediately upon conclusion of a predetermined waiting period or a predefined time range. Similarly, time lags caused by a failure of the ACC 140 will become known as soon as the bags 136, 137 are delivered to the bank processing facility. Using the system 100 also enables the bank to credit good customers upon deposit of funds rather than receipt at the bank central facility.

The deposit system may include other features such as those described below. The deposit system may include at least one housing. At least one safe may be disposed in one such housing which is separate from any housing of any other of the safes. The deposit containers may have a pre-defined series of identifiers for containers containing cash deposits and a pre-defined series of identifiers for containers containing non-cash deposits. When the deposit processor identifies the deposit scanned by the user, the deposit processor may produce a signal to signal the user to deposit the deposit in the safe corresponding to the type of deposit, i.e. cash or non-cash, the signal indicating the safe in which to make the deposit. The signal can include a visual signal and an audible signal. The safes of the deposit system may include a plurality of safes in reconfigurable arrangements thereof. The deposit system may further include a means for producing a signal indicating identification by said second reader upon the uniquely identified deposit container containing the deposit being removed from the safe into which the deposit was received, the signal being an incremental numeric count of the uniquely identified deposit containers removed as aforesaid. The signal may be an audible signal. The serviceable equipment in the deposit system may be monitored electronically to maintain a status of the serviceable equipment.

The deposit system for receiving a deposit from a user may include a deposit processor having a user interface to permit the user to communicate deposit information to the deposit processor before the user makes the deposit, at least one safe operatively attached to the deposit processor and being configured to receive the deposit, each safe further having a first lockable access thereto, at least one housing wherein at least one safe is disposed in a housing which is separate from a corresponding housing of any other safe and a reader, operatively connected to the deposit processor, to read a label of the deposit so as to identify the deposit, wherein upon the deposit being identified, the deposit processor unlocks the first lockable access corresponding to one of the safes to permit the user to deposit the deposit therein.

The deposit system for receiving a deposit from a user may include a deposit processor having a user interface to permit the user to communicate deposit information to the deposit processor before the user makes the deposit, a plurality of safes operatively attached to the deposit processor in reconfigurable arrangements thereof, each safe being configured to receive the deposit and having a first lockable access thereto and a reader, operatively connected to the deposit processor, to read a label of the deposit so as to identify the deposit, wherein upon the deposit being identified, the deposit processor unlocks the lockable access corresponding to one of the plurality of safes to permit the user to deposit the deposit therein.

It will be appreciated by those skilled in the art that the foregoing description was in respect of preferred embodiments and that various alterations and modifications are possible within the broad scope of the appended claims without departing from the spirit of the invention.

1. A deposit system for receiving a deposit from a user, said deposit system comprising:
(a) a deposit processor having a user interface to permit the user to communicate deposit information to the deposit processor before the user makes said deposit, said deposit information including an indication of type of said deposit as being one of a cash deposit and a non-cash deposit;
(b) at least one safe operatively attached to the deposit processor, each said safe being configured to receive at least one of a cash deposit and a non-cash deposit and each said safe having a first lockable access thereto, said at least one safe capable of receiving cash deposits and non-cash deposits; and
(c) a reader, operatively connected to the deposit processor, to read a label of said deposit to identify said deposit using said deposit information;
wherein, upon said deposit being identified, said deposit processor unlocks said first lockable access for one of said at least one safe to permit said user to deposit said deposit therein.

2. The deposit system recited in claim 1, wherein each said first lockable access comprises a lockable transfer slot and each said safe further includes a second lockable access for removing deposits deposited therein.

3. The deposit system recited in claim 2, wherein at least one of said safes includes a drop sensor to sense passing of said deposit through the lockable transfer slot thereof.

4. The deposit system recited in claim 1, wherein the user interface includes a user identification means to identify the user.

5. The deposit system recited in claim 4, wherein the user identification means includes a card reader.

6. The deposit-system recited in claim 5, the deposit system further including a remote processor and wherein said deposit processor communicates user identification information and said deposit information to said remote processor.

7. The deposit system recited in claim 1, the deposit system further including a remote terminal, wherein the remote terminal is configured to permit the user to communicate said deposit information remotely to the deposit processor.

8. The deposit system recited in claim 1, the deposit system further including a controller cabinet having serviceable equipment located behind a lockable door, the controller cabinet housing the deposit processor and the reader, the lockable door being separate from each of said first lockable accesses.

9. The deposit system recited in claim 8, the deposit system further including at least one sensor associated with said serviceable equipment to sense a status of the serviceable equipment to facilitate servicing the serviceable equipment.

10. The deposit system recited in claim 1, wherein the deposit system comprises at least two safes and wherein one safe of said at least two safes operates to receive cash deposits and another safe of said at least two safes operates to receive non-cash deposits, each of said at least two safes being operatively connected to said deposit processor.

11. The deposit system recited in claim 10, wherein said one safe which operates to receive cash deposits is more securely built than said another safe which operates to receive non-cash deposits.

12. The deposit system recited in claim 11, wherein each said first lockable access of each said safe includes a lockable transfer slot operatively connected to said deposit processor to receive said deposit therein and each said safe further comprises a second lockable access through which to access said safe for removing deposits deposited therein.

13. The deposit system recited in claim 1, wherein the deposit system comprises at least two safes and wherein one safe of said at least two safes operates to receive deposits to be deposited in an account held by a first financial institution and another safe of said at least two safes operates to receive deposits to be deposited in an account held by a second financial institution, each of said at least two safes being operatively connected to said deposit processor.

14. The deposit system recited in claim 1, wherein the deposit system comprises at least two safes and wherein one safe of said at least two safes operates to receive deposits to be processed by a first processing facility and another safe of said at least two safes operates to receive deposits to be processed by a second processing facility, each of said at least two safes being operatively connected to said deposit processor.

15. The deposit system recited in claim 1, wherein said reader is one of a bar-code reader, a radio frequency reader, a magnetic strip reader and an optical character recognition reader.

16. The deposit system recited in claim 1, the deposit system further including a means to read said label of said deposit upon said deposit being removed from said safe into which said deposit was received.

17. The deposit system recited in claim 16, wherein said reader is a first reader and said means to read said label upon said deposit being removed from the safe into which said deposit was received comprises a second reader.

18. The deposit system recited in claim 17, the deposit system further including a means for producing a signal indicating identification by said second reader upon said deposit being removed from said safe into which said deposit was received.

19. The deposit system recited in 17, wherein said second reader is one of a bar-code reader, a radio frequency reader, a magnetic strip reader and an optical character recognition reader.

20. The deposit system recited in claim 1, the deposit system further including at least one deposit container bearing said label of said deposit in which said user places said deposit.

21. The deposit system recited in claim 20, wherein said label includes a unique identifier.

22. The deposit system recited in claim 21, wherein said deposit information includes said unique identifier to identify the deposit container containing said deposit.

23. The deposit system recited in claim 22, wherein said deposit information further includes at least one of an identity of said user, an amount of said deposit and an identity of an account into which said deposit is directed to be deposited.

24. The deposit system recited in claim 21, wherein said label includes at least one of an optical bar-code, an electronic radio frequency tag, a magnetic encoding strip and alphanumeric text.

25. A deposit system for receiving deposits, comprising at least one secure deposit unit configured to receive at least one uniquely identified deposit container from a user, each said deposit unit including user identification means for identifying the user and deposit container identification means for identifying each said uniquely identified deposit container upon deposit by the user at one deposit unit of said at least one deposit unit, each said uniquely identified deposit container being configured to contain a type of deposit being one of a cash deposit and a non-cash deposit, but not both.

26. The deposit system recited in claim 25, the deposit system further including a remote user terminal and a remote processor, said remote processor being configured to communicate with each said deposit unit, and said remote user terminal being configured to receive input from the user and communicate deposit details to the remote processor, said deposit details including an identity of the user and an identity of the uniquely identified deposit container to be deposited by the user at said one deposit unit.

27. The deposit system recited in claim 25, wherein each said uniquely identified deposit container containing a cash deposit is differentiated from each said uniquely identified deposit container containing a non-cash deposit.

28. The deposit system recited in claim 25, wherein each said deposit unit includes a first safe configured to receive any of each said uniquely identified deposit container containing a cash deposit, and a second safe configured to receive any of each said uniquely identified deposit container containing a non-cash deposit.

29. The deposit system recited in claim 28, wherein each of said first and second safes of each said deposit unit is independently accessible.

30. The deposit system recited in claim 25, wherein each said deposit unit comprises at least two safes and wherein one safe of said at least two safes operates to receive deposits to be deposited in an account held by a first financial institution and another safe of said at least two safes operates to receive deposits to be deposited in an account held by a second financial institution.

31. The deposit system recited in claim 25, wherein each said deposit unit comprises at least two safes and wherein one safe of said at least two safes operates to receive deposits to be processed by a first processing facility and another safe of said at least two safes operates to receive deposits to be processed by a second processing facility.

32. The deposit system recited in claim 25, wherein said deposit container identification means is a first deposit container identification means and each said deposit unit further includes a second deposit container identification means for identifying each said uniquely identified deposit container deposited therein upon removal from said deposit unit.

33. The deposit system recited in claim 25, wherein each said uniquely identified deposit container is uniquely identified by means of an identification system associated therewith.

34. The deposit system recited in claim 33, wherein each said identification system is one of an optical bar-coding system, an electronic radio frequency system, a magnetic encoding system and an optical character recognition system.

35. The deposit system recited in claim 32, wherein each said deposit unit further includes a means for producing a signal indicating identification by said second deposit container identification means of each said uniquely identified deposit container deposited therein upon removal from said deposit unit.

36. A method of receiving a deposit from a user, said deposit being received at a deposit unit, said method comprising the steps of:
(i) identifying the user making said deposit, said deposit contained in an uniquely identified deposit container being configured to contain a type of deposit being one of a cash deposit and a non-cash deposit, but not both; and
(ii) identifying the uniquely identified deposit container upon deposit at the deposit unit.

37. The method recited in claim 36, further comprising the steps of:
prior to step (i), accepting deposit details from the user from a remote location, said deposit details including an identity of the user and an identity of the uniquely identified deposit container to be deposited at the deposit unit; and
prior to step (i), storing the deposit details by a remote processor configured for communication with the deposit unit, said remote processor being located remotely of the deposit unit.

38. The method recited in claim 36, wherein each said uniquely identified deposit container containing a cash deposit is differentiated from each said uniquely identified deposit container containing a non-cash deposit.

39. The method recited in claim 38, the method further comprising the step of, prior to step (i), providing a first safe and a second safe at said deposit unit, said first safe configured to receive said uniquely identified deposit container if said uniquely identified deposit container contains a cash deposit, and said second safe configured to receive said uniquely identified deposit container if said uniquely identified deposit container contains a non-cash deposit.

40. The method recited in claim 36, the method further comprising the step of, prior to step (i), providing a first safe and a second safe at said deposit unit, said first safe configured to receive said uniquely identified deposit container if said uniquely identified deposit container is to be deposited in an account held by a first financial institution, and said second safe configured to receive said uniquely identified deposit container if said uniquely identified deposit container is to be deposited in an account held by a second financial institution.

41. The method recited in claim 36, the method further comprising the step of, prior to step (i), providing a first safe and a second safe at said deposit unit, said first safe configured to receive said uniquely identified deposit container if said deposit contained in said uniquely identified deposit container is to be processed by a first processing facility, and said second safe configured to receive said uniquely identified deposit container if said deposit contained in said uniquely identified deposit container is to be processed by a second processing facility.

42. The method recited in claim 36, the method further comprising the step of uniquely identifying the uniquely identified deposit container by means of an identification system associated therewith.

43. The method recited in claim 42, wherein said identification system is one of an optical bar-coding system, a radio frequency electronic system, a magnetic encoding system and an optical character recognition system.

44. The method recited in claim 36, the method further including the steps of collecting the uniquely identified deposit container deposited in said deposit unit and identifying the uniquely identified deposit container as same is collected.

45. The method recited in claim 44, the method further including the step of signalling collection of the uniquely identified deposit container as same is collected.

46. The method recited in claim 36, the method further including the step of collecting deposit information pertaining to contents of the uniquely identified deposit container prior to deposit thereof in said deposit unit, said deposit information including amount of said deposit.

47. The method recited in claim 46, the method further including the step of scheduling collection of the uniquely identified deposit container according to said deposit information.

48. The method recited in claim 46, wherein said deposit information includes type of deposit contained in the uniquely identified deposit container as one of a cash deposit and a non-cash deposit.

49. The method recited in claim 36, wherein the deposit unit has serviceable equipment and the method further includes the step of monitoring the serviceable equipment electronically to maintain a status of the serviceable equipment.

50. A deposit system for receiving a deposit from a user, said deposit system comprising:
(a) a deposit processor having a user interface to permit the user to communicate deposit information to said deposit processor before said user makes said deposit;
(b) at least one safe operatively attached to said deposit processor, each said safe being configured to receive said deposit and having a first lockable access thereto;
(c) a first reader, operatively connected to said deposit processor, to read a label of said deposit so as to identify said deposit, wherein upon said deposit being identified, said deposit processor unlocks said first lockable access corresponding to one safe of said at least one safe to permit said user to deposit said deposit therein; and
(d) a second reader, operatively connected to said deposit processor, to read said label of said deposit upon said deposit being removed from said one safe.
